(19) United States
(12) Patent Application Publication
(10) Pub. No.: US 2012/0153579 A1
(43) Pub. Date: Jun. 21, 2012

(54) METAL GASKET AND METHOD FOR MANUFACTURING DIE FOR METAL GASKET

(76) Inventors: Shinya Nakaoka, Fukushima (JP); Isao Tanji, Fukushima (JP); Masaru Ito, Fukushima (JP)

(21) Appl. No.: 13/390,678

(22) PCT Filed: Aug. 24, 2010
(86) PCT No.: PCT/JP2010/064287

§ 371 Date: Feb. 15, 2012

(30) Foreign Application Priority Data
Aug. 26, 2009 (JP) 2009-195396

(51) Int. Cl. F16J 15/02; B21K 5/20

(52) U.S. Cl. 277/644; 76/107.1

(57) ABSTRACT

[Problem] To provide a metal gasket capable of realizing a uniform surface pressure by a bead of the metal gasket and a uniform collapse ratio of the bead, while restricting deformation of flanges upon bolt fastening.

[Mechanism for Solving the Problem] A metal gasket to be provided for sealing joint surfaces between two members. The metal gasket includes: a flow passage opening (4) which corresponds to a flow passage definitely provided between and through the two members; multiple bolt holes (3), through which bolts for tightening the two members to each other are penetrated, respectively; and a bead (5). The bead (5) is configured with a height and a width which become higher and wider from the vicinity of each bolt hole (3) in a direction separating therefrom, respectively.

### TECHNICAL FIELD

The present invention relates to a metal gasket and a method for manufacturing a die for a metal gasket, and relates particularly to a metal gasket capable of realizing a uniform surface pressure by a bead and a uniform collapse ratio of the bead upon sealing joint surfaces between two members while restricting deformations of flanges of the two members; and a method for manufacturing a die for the metal gasket, which die is capable of inexpensively fabricating such a metal gasket.

### BACKGROUND ART

Conventionally, metal gaskets have each been used to seal joint surfaces between two members in an oil pan, inverter case, transmission case, or the like. Examples of metal gaskets include: a pre-coated type of metal gasket to be fabricated by forming a seal material made of an elastic body into a layer on a metal sheet made of cold rolled steel, stainless steel, or the like to establish a gasket material, and by stamping it by a press; an after-coated type of metal gasket comprising a steel plate stamped into a desired shape, and a seal material made of an elastic body thereon formed into a layered shape by screen coating, for example; and the like. Such metal gaskets are frequently formed with beads, respectively, so as to improve sealability between joint surfaces.

In case of sealing joint surfaces between two members by a metal gasket having a bead, bolts are penetrated through bolt holes formed at respective flanges of the two members and at the metal gasket to fasten the two members integrally with the metal gasket, thereby carrying out a sealing therebetween. The metal gasket is collapsed along its bead between the flanges to generate a predetermined surface pressure, thereby exhibiting a sealing effect.

At this time, the flanges are subjected to an action of a repulsive force from the collapsed bead, in a manner to bring about a force tending to deform the flanges. In this case, this is not problematic, insofar as the flanges of the members have sufficient rigidities, respectively. However, it is occasional in case of an oil pan, inverter case, or the like, that the cooperative flanges clamping a metal gasket therebetween is insufficient in rigidity against such a repulsive force from a bead, thereby bringing about a possibility of deformation of the flanges due to insufficient rigidities thereof.

Deformation of the flanges results in a situation that a gap between the flanges positioned in-between two adjacent bolts is increased as compared to a gap between the flanges positioned just below each bolt (i.e., a situation that the compressed amount of the gasket is decreased), so that the metal gasket is not sufficiently compressed between the flanges at the location of the increased gap, thereby bringing about a defect of a deteriorated sealability.

Thus, various gasket structures have been conventionally proposed, so as to ensure a sealability over the entirety of sealed surfaces to thereby overcome the aforementioned defect.

FIG. 24 is a plan view showing a conventional metal gasket 100 having a flow passage opening 101 and four bolt holes 102, and FIG. 25(a) is a line a₁-a₁ cross-sectional view of FIG. 24, (b) is a line b₁-b₁ cross-sectional view, (c) is a line c₁-c₁ cross-sectional view, and (d) is a line d₁-d₁ cross-sectional view, of FIG. 24.

It includes a bead 103 formed as a full bead in each region between adjacent two bolt holes 102, and formed as half beads in each region near an associated bolt hole 102 around its outer circumference in a manner to surround the bolt hole 102.

In the metal gasket 100, the bead 103 is configured to have a width W which becomes narrower from the vicinity of each bolt hole 102 in a direction separating from the bolt hole 102. As a result, the bead 103 is configured to have a height H that becomes higher from the vicinity of each bolt hole 102 in a direction separating from the bolt hole 102.

Such a metal gasket is described in Patent Document 1, for example.

Further, FIG. 26 is a plan view showing another conventional metal gasket 200 having a flow passage opening 201 and four bolt holes 202, and FIG. 27(a) is a line a₂-a₂ cross-sectional view of FIG. 26, (b) is a line b₂-b₂ cross-sectional view, (c) is a line c₂-c₂ cross-sectional view, and (d) is a line d₂-d₂ cross-sectional view, of FIG. 26.

It includes a bead 203 formed as a half bead over its entire circumference.

Also in the metal gasket 200, the bead 203 is configured to have a width W which becomes narrower from the vicinity of each bolt hole 202 in a direction separating from the bolt hole 202. As a result, the bead 203 is configured to have a height H that becomes higher from the vicinity of each bolt hole 202 in a direction separating from the bolt hole 202.

Such a metal gasket is described in Patent Document 2, for example.

### Prior Art Documents:

### Patent Documents:

Patent Document 1: JP-A-H08-93918

Patent Document 2: JP-A-S61-255250

Patent Document 3: JP-A-S61-52938

Patent Document 4: JP-A-H01-215416

### DISCLOSURE OF THE INVENTION

### Problem to be Solved by the Invention

It is possible to vary a repulsive characteristic of a bead by varying a height, width, and the like of the bead. However, in case of forming a bead by bending a metal sheet, the bead is caused to have a smaller bead height at each portion having a wider bead width and a greater bead height at each portion having a narrower bead width, due to a spring back to be caused by bending.

According to the aforementioned conventional techniques, bead widths between bolt holes are made to be narrow. Thus, it seems that each bead is caused to have an increased bead height at each portion between adjacent bolt holes such that the bead is made to be readily contacted with joint surfaces between flanges upon sealing at each portion of the bead between the bolt holes, and it seems that the sealability is improved by virtue of the improved repulsive characteristic, as compared to a gasket having a bead of a uniform bead height and a uniform bead width.

However, when the bead is made to be narrower in width and increased in height between bolt holes, it becomes difficult for the bead to be collapsed in a manner to exhibit an increased repulsive force upon tightening associated flanges by bolts, and such an increased repulsive force leads to an increased force tending to deform the flanges. This results in promotion of deformation of flanges due to insufficient rigidities of the flanges, particularly when the cooperative flanges do not have sufficient rigidities against the repulsive force of the bead such as in case of an oil pan, inverter case, or the like, thereby failing to resultingly solve the problem of deteriorated sealability.

Further, in case of a metal gasket such as the metal gasket 100 as shown in FIG. 24 having the bead 103 formed as half beads in each region near the associated bolt hole 102 around its outer circumference in a manner to surround the bolt hole 102, it is intended that the half bead portion of the bead 103 outside each bolt hole 102 serves as a stopper upon tightening by a bolt in a manner to reduce a gap inside the bolt hole 102 than a gap outside the bolt hole 102, thereby decreasing an opened amount of the flanges between bolt holes 102.

However, by such a bead configuration, it has been likely as shown in FIG. 28 that the bead is deteriorated in sealability at its portion of each bolt hole 102 for penetrating a bolt 300 therethrough to cause a possibility of leakage, in case that an inside bead line (bead contact line) 103a of a concaved side of the bead 103 is droppedly positioned out of an applicable one of joint surfaces fa of flanges f1, f2 of applicable two members.

It is therefore an object of the present invention to provide a metal gasket capable of realizing a uniform surface pressure by a bead of the metal gasket and a uniform collapse ratio of the bead, while restricting deformation of flanges upon bolt fastening.

It is another object of the present invention to provide a method for manufacturing a die for metal gasket, which method is capable of inexpensively manufacturing a die for producing a metal gasket comprising a bead having a height and a width both varied over an entire circumference of a gasket body.

Other objects of the present invention will become apparent from the following description.

### Means for Solving Problem

The above object is carried out by the following inventions.

The invention of claim 1 resides in a metal gasket to be provided for sealing joint surfaces between two members, the metal gasket comprising: a flow passage opening which corresponds to a flow passage definitely provided between and through the two members; multiple bolt holes, through which bolts for tightening the two members to each other are penetrated, respectively; and a bead; wherein the bead is configured to have a height and a width which become higher and wider from the vicinity of each bolt hole in a direction separating therefrom, respectively.

The invention of claim 2 resides in the metal gasket according to claim 1, wherein the height and width of the bead become progressively higher and wider from the vicinity of each bolt hole in the direction separating therefrom, respectively.

The invention of claim 3 resides in the metal gasket according to claim 1 or 2, wherein the bead is formed as a full bead in each region between adjacent two bolt holes, and formed as half beads in each region near an associated bolt hole in a manner to surround the bolt hole.

The invention of claim 4 resides in the metal gasket according to claim 3, wherein the bead is formed as a trapezoidal bead in each region between adjacent two bolt holes, such that the trapezoidal bead has a top surface formed as a flat surface.

The invention of claim 5 resides in the metal gasket according to claim 1 or 2, wherein the bead is entirely formed as a full bead, and the bead is formed to be positioned near each bolt hole in a manner to pass between the bolt hole and the flow passage opening.

The invention of claim 6 resides in the metal gasket according to claim 1 or 2, wherein the bead is entirely formed as a half bead, and the bead is formed to be positioned near each bolt hole in a manner to pass between the bolt hole and the flow passage opening.

The invention of claim 7 resides in a method for manufacturing a die for metal gasket, the die being adapted to produce a metal gasket comprising a gasket body and a bead, the bead having a height and a width varied over an entire circumference of the gasket body, the method comprising:
a first cutting out step configured to lay a male die plate and a corresponding female die plate one on top of the other, and to form a first cut-out through both the die plates, along a bead shape to be produced;
a second cutting out step configured to mount the male die plate and a corresponding female die plate after the first cutting-out operation, onto oppositely arranged pressing machine plates, respectively, and to subsequently conduct a second cutting-out operation, which is set to be wider commensurately with a width variation of the bead to be produced, for the first cut-out in the female die plate;
a protrusive part forming step configured to form, from a metal plate, a die protrusive part for determining a bead height, in a manner that the protrusive part has a height variation commensurate with a height variation of the bead to be produced; and
a protrusive part fixing step configured to insert and fix the protrusive part formed by the protrusive part forming step, into the first cut-out in the male die plate which first cut-out has been cut out by the first cutting out step.

The invention of claim 8 resides in a method for manufacturing a die for metal gasket, the die being adapted to produce a metal gasket comprising a gasket body and a bead, the bead having a height and a width varied over an entire circumference of the gasket body, the method comprising:
a steel plate block forming step configured to stack multiple steel plates, and to conduct a cutting-out operation throughout all the steel plates commensurately with a width variation of the bead to be produced, thereby forming two steel plate blocks; and
a mounting and adjusting step configured to mount the formed steel plate blocks onto oppositely arranged pressing machine plates, respectively, by adjusting the numbers of constituent steel plates of the steel plate blocks at respective locations in the circumferential direction commensurately with the variation of the bead height.

The invention of claim 9 resides in the method for manufacturing a die for metal gasket according to claim 8, wherein those topmost ones of the steel plates mounted on the pressing machine plates, each comprise a single steel plate which is continuous over an entire circumference thereof.

The invention of claim 10 resides in a method for manufacturing a die for metal gasket, the die being adapted to produce a metal gasket comprising a gasket body and a bead, the bead having a height and a width varied over an entire circumference of the gasket body, the method comprising:
a first cutting out step configured to lay a male die plate and a corresponding female die plate one on top of the other, and to form a first cut-out through both the die plates, along a bead shape to be produced;
a second cutting out step configured to mount the male die plate and the corresponding female die plate after the first cutting-out operation, onto oppositely arranged pressing machine plates, respectively, and to subsequently conduct a second cutting-out operation for forming a second cut-out, which is set to be wider commensurately with a width variation of the bead to be produced and which is shallower than the first cut-out;
a protrusive part forming step configured to form, from a metal plate, a pair of die protrusive parts for determining a bead height, in a manner that the pair of protrusive parts cooperatively have a height variation commensurate with a height variation of the bead to be produced; and
a protrusive part fixing step configured to insert and fix one of the pair of protrusive parts formed by the protrusive part forming step into the first cut-out in the male die plate, to fix the protrusive part in the first cut-out, and to insert and fix the other of the pair of protrusive parts into the first cut-out in the female die plate.

The invention of claim 11 resides in the method for manufacturing a die for metal gasket according to claim 10, wherein the metal plate comprises a single metal plate, and the protrusive part forming step is configured: to form a shaped plane in the single metal plate which shaped plane has a height variation commensurate with the height variation of the bead to be produced, in a manner to divide the single metal plate into two metal plates along and from the shaped plane interposed therebetween; and to constitute the protrusive parts of the male die plate and the corresponding female die plate by one and the other of the dividedly obtained metal plates, respectively.

### EFFECT OF THE INVENTION

According to the present invention, it is possible to provide a metal gasket capable of realizing a uniform surface pressure by a bead of the metal gasket and a uniform collapse ratio of the bead, while restricting deformation of flanges upon bolt fastening.

Further, according to the present invention, it is possible to provide a method for manufacturing a die for metal gasket, which method is capable of inexpensively manufacturing a die for producing a metal gasket comprising a bead having a height and a width both varied over an entire circumference of a gasket body.

### BRIEF DESCRIPTION OF THE DRAWINGS

FIG. 1 is a plan view of a first embodiment of a metal gasket according to the present invention;

FIG. 2(a) is a line A₁-A₁ cross-sectional view of FIG. 1, (b) is a line B₁-B₁ cross-sectional view, (c) is a line C₁-C₁ cross-sectional view, and (d) is a line D₁-D₁ cross-sectional view, of FIG. 1;

FIG. 3 is a plan view of a second embodiment of a metal gasket according to the present invention;

FIG. 4 is a line E-E cross-sectional view of FIG. 3;

FIG. 5 is a cross-sectional view of bolt hole portions of flanges equipped with the metal gasket according to the second embodiment;

FIG. 6 is a plan view of a third embodiment of a metal gasket according to the present invention;

FIG. 7(a) is a line A₂-A₂ cross-sectional view of FIG. 6, (b) is a line B₂-B₂ cross-sectional view, (c) is a line C₂-C₂ cross-sectional view, and (d) is a line D₂-D₂ cross-sectional view, of FIG. 6;

FIG. 8 is a plan view of a fourth embodiment of a metal gasket according to the present invention;

FIG. 9(a) is a line A₃-A₃ cross-sectional view of FIG. 8, (b) is a line B₃-B₃ cross-sectional view, (c) is a line C₃-C₃ cross-sectional view, and (d) is a line D₃-D₃ cross-sectional view, of FIG. 8;

FIG. 10 is an explanatory view of a first embodiment of a manufacturing method of the present invention;

FIG. 11 is another explanatory view of the first embodiment of the manufacturing method of the present invention;

FIG. 12 is a still another explanatory view of the first embodiment of the manufacturing method of the present invention;

FIG. 13 is a yet another explanatory view of the first embodiment of the manufacturing method of the present invention;

FIG. 14 is a still further explanatory view of the first embodiment of the manufacturing method of the present invention;

FIG. 15 is an explanatory view of a second embodiment of a manufacturing method of the present invention;

FIG. 16 is another explanatory view of the second embodiment of the manufacturing method of the present invention;

FIG. 17 is a still another explanatory view of the second embodiment of the manufacturing method of the present invention;

FIG. 18 is a yet another explanatory view of the second embodiment of the manufacturing method of the present invention;

FIG. 19 is a still further explanatory view of the second embodiment of the manufacturing method of the present invention;

FIG. 20 is an explanatory view of a third embodiment of a manufacturing method of the present invention;

FIG. 21 is another explanatory view of the third embodiment of the manufacturing method of the present invention;

FIG. 22 is a still another explanatory view of the third embodiment of the manufacturing method of the present invention;

FIG. 23 is a yet another explanatory view of the third embodiment of the manufacturing method of the present invention;

FIG. 24 is a plan view of an example of a conventional metal gasket;

FIG. 25(a) is a line a₁-a₁ cross-sectional view of FIG. 24, (b) is a line b₁-b₁ cross-sectional view, (c) is a line c₁-c₁ cross-sectional view, and (d) is a line d₁-d₁ cross-sectional view, of FIG. 24;

FIG. 26 is a plan view of another example of a conventional metal gasket;

FIG. 27(a) is a line a₂-a₂ cross-sectional view of FIG. 26, (b) is a line b₂-b₂ cross-sectional view, (c) is a line c₂-c₂ cross-sectional view, and (d) is a line d₂-d₂ cross-sectional view, of FIG. 26; and

FIG. 28 is a cross-sectional view of bolt hole portions of flanges of two members equipped with the conventional metal gasket.

### EXPLANATION OF LETTERS OR NUMERALS

1A, 1B, 1C, 1D: metal gasket

2: gasket body

3: bolt hole

4: flow passage opening

5, 6, 7, 8: bead

5a, 5b, 7a, 8a, 8b, 8d, 8e: inclined surface

5c, 6c, 8c, 8f: top portion

6a: inside bead line

6b: outside bead line

20, 40: machine plate

20a: positioning pin

21: male die plate

22: female die plate

23, 26, 27: fixture

24, 25, 42, 43: pressing machine plate

30: metal plate

31: protrusive part

41: steel plate

41a to 41d: steel plate block

41A to 41D: topmost steel plate

X1, X2, X3, X4: cut-out

### BEST MODE(S) FOR CARRYING OUT THE INVENTION

Embodiments of the present invention will be explained hereinafter.

### First Embodiment of Metal Gasket

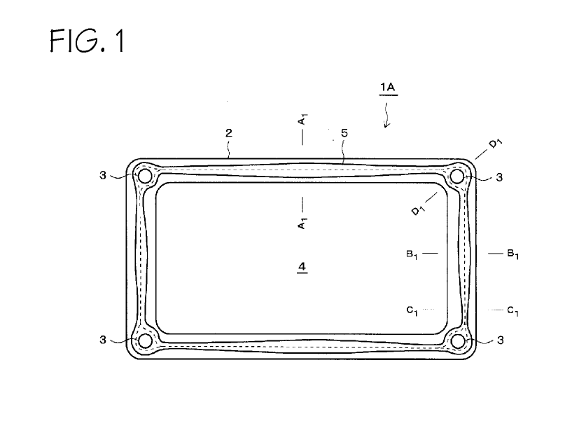

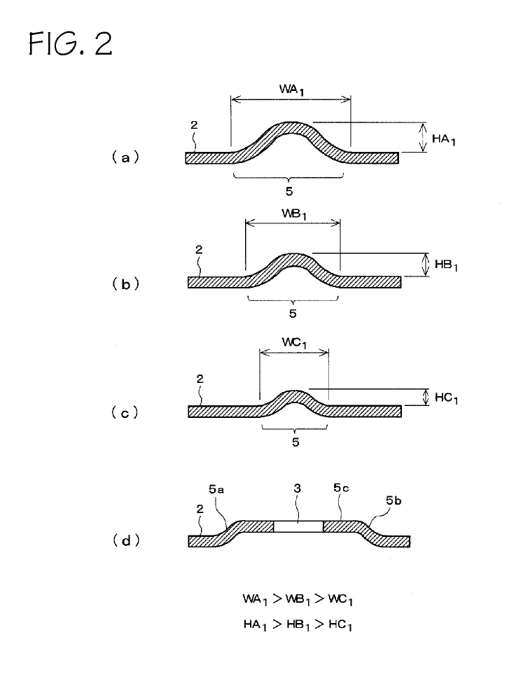

FIG. 1 is a plan view of a first embodiment of a metal gasket according to the present invention, and FIG. 2(a) is a line A₁-A₁ cross-sectional view of FIG. 1, (b) is a line B₁-B₁ cross-sectional view, (c) is a line C₁-C₁ cross-sectional view, and (d) is a line D₁-D₁ cross-sectional view, of FIG. 1.

The metal gasket 1A shown in these figures is clampedly installed between joint surfaces of two members (not shown) constituting an oil pan, inverter case, or the like, for example.

The metal gasket 1A comprises: a gasket body 2 which is a plate-like member made of metal; multiple bolt holes 3, through which bolts for tightening applicable two members to each other are penetrated, respectively, upon installation of the metal gasket between the two members; a flow passage opening 4 to be provided commensurately with a flow passage definitely provided between and through the two members; and a bead 5 provided on the gasket body 2 in a manner to surround an outer circumference of the flow passage opening 4.

Although the bolt holes 3 are provided at four corners of the rectangular gasket body 2 here, respectively, it is enough in the present invention that the bolt holes 3 are provided plurally, and that the gasket body 2 has a completely arbitrary shape in plan view. Further, the gasket body 2 may be provided as a single-layered metal plate, or a laminated plate comprising a sheet(s) made of metal and a seal material(s) made of elastic body.

Such a metal gasket 1A is compressed between two members by fastening the two members therewith by bolts penetrated through bolt holes formed at flanges of the two members and through the bolt holes 3 matching with the bolt holes, respectively, and at this time, the bead 5 is closely contacted with a joint surface of one of the two members, thereby forming a sealing portion around the outer circumference of the flow passage opening 4. This prevents leakage of a fluid from the flow passage opening 4.

The bead 5 in this embodiment is formed as a full bead protruded into a mound shape from the gasket body 2 in each region between adjacent two bolt holes 3, 3 (see FIGS. 2(a), (b), and (c)), and formed as half beads in each region near an associated bolt hole 3, which half beads are divided inwardly (flow passage opening 4 side) and outwardly around the associated bolt hole 3 as a boundary and are formed to exhibit inclined surfaces 5a, 5b upwardly inclined from inner and outer edges of the gasket body 2 toward the bolt hole 3, respectively, in a manner to surround an outer circumference of the bolt hole 3 (see FIG. 2(d)). Each bolt hole 3 is opened at a flat surface 5c formed over top portions of the inclined surfaces 5a, 5b.

In this metal gasket 1A, the bead 5 is configured to have a height H and a width W which become higher and wider from the vicinity of each bolt hole 3 in a direction separating therefrom, respectively. Preferably, the height H and width W of the bead 5 become progressively higher and wider from the vicinity of each bolt hole 3 in the direction separating therefrom, respectively.

It is noted that the term vicinity of each bolt hole 3 means an outer circumferential region around the bolt hole 3, in the present invention.

This results in that the heights H and widths W of the bead 5 in regions positioned between applicable adjacent two bolt holes 3, 3 are both formed to be greater than the heights H and widths W of the bead 5 in regions near applicable bolt holes 3, respectively, as shown in FIG. 2(a) to (c) (HA₁>HB₁>HC₁, WA₁>WB₁>WC₁).

Thus, when flanges of two members are fastened integrally with each other by clamping such a metal gasket 1A between joint surfaces of the flanges, even the bead 5 having the lower height H and the narrower width W is subjected to application of a relatively strong tightening pressure near each bolt hole 3 to thereby ensure a predetermined sealability, while ensuring a predetermined surface pressure by virtue of the formation of the greater height H of the bead 5 in each region between applicable bolt holes 3, 3 where a deterioration of sealability is a concern due to the tightening pressure lowered in a direction separating from each bolt hole 3. Moreover, since the bead 5 is configured to have the wider width W in each region between the associated bolt holes 3, 3, the bead 5 becomes apt to be compressed (i.e., apt to be collapsed), though the height H of the bead 5 is increased in such a region. This never promotes deformation of flanges even when they have lower rigidities, so that the bead 5 is allowed to have a collapse ratio (compression ratio) which is kept at substantially the same level over the entire circumference of the bead 5, thereby enabling to obtain a uniform surface pressure and to ensure a higher sealability.

### Second Embodiment of Metal Gasket

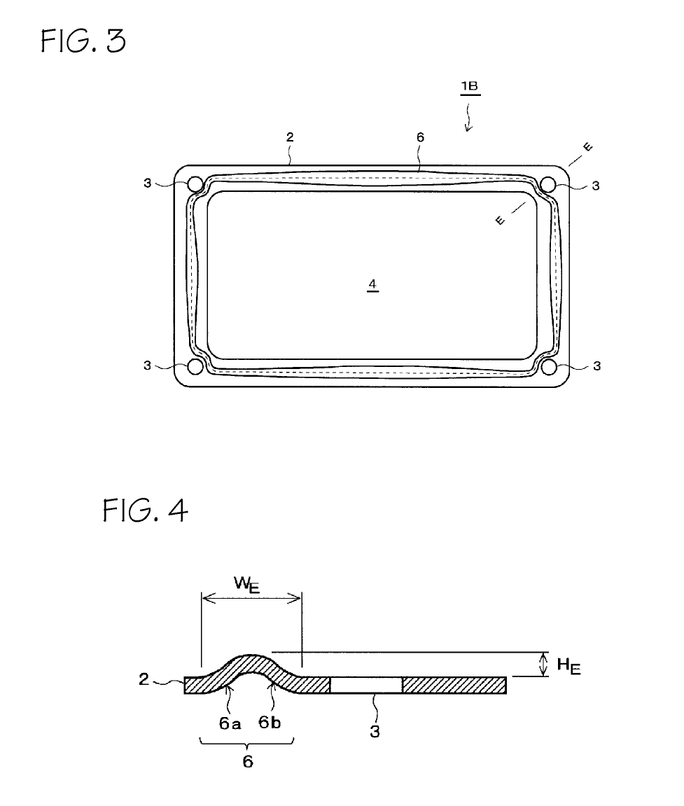

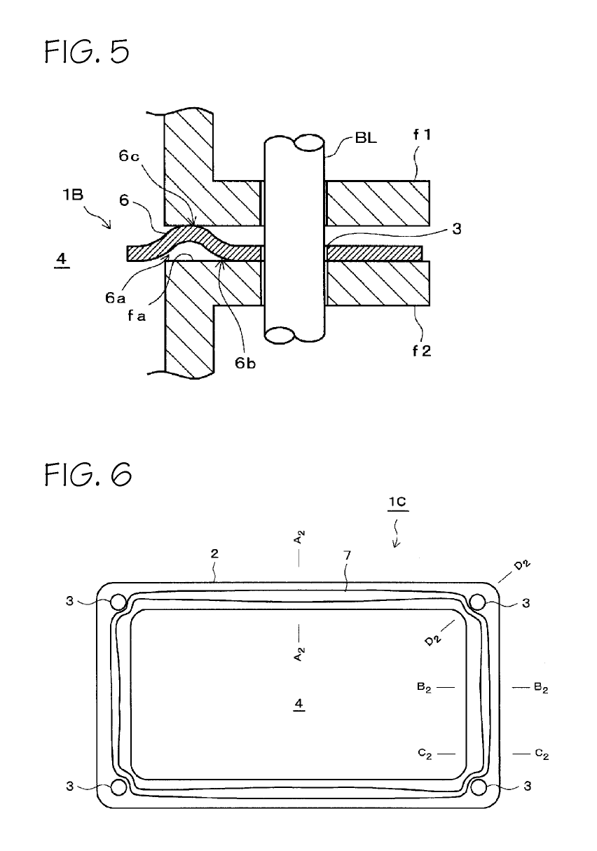

FIG. 3 is a plan view of a second embodiment of a metal gasket according to the present invention, FIG. 4 is a line E-E cross-sectional view of FIG. 3, and FIG. 5 is a cross-sectional view of bolt hole portions of flanges equipped with the metal gasket according to the second embodiment. Since those components having the same reference numerals as those in FIG. 1 have the same configurations as them, respectively, the detailed description thereof is omitted here.

The metal gasket 1B comprises a bead 6 formed as a full bead protruded into a mound shape from the gasket body 2 over the entire circumference thereof (see FIG. 4), in a manner that the heights H and widths W of the bead in regions positioned between applicable adjacent two bolt holes 3, 3 are the same configuration as those in the first embodiment. It is noted that the bead 6 is configured to have such a height H near each bolt hole 3, which height is smaller than that at the location farthest from the bolt hole 3 (location corresponding to FIG. 2(a) in the first embodiment).

This bead 6 is formed to have a portion positioned near each bolt hole 3, which portion is passed between the bolt hole 3 and the flow passage opening 4.

This leads to a situation as shown in FIG. 5 that, even when an inside bead line 6a of a concaved side of the bead 6 is droppedly positioned out of an applicable one of joint surfaces fa of flanges f1, f2 at a location near the applicable bolt hole 3 through which a bolt BL is penetrated, it is still possible to keep the sealing by means of an outside bead line 6b of the concaved side of the bead 6 and a top portion 6c thereof, thereby enabling to further enhance the sealability without a possibility of leakage of a fluid from the flow passage opening 4 through the bolt hole 3.

### Third Embodiment of Metal Gasket

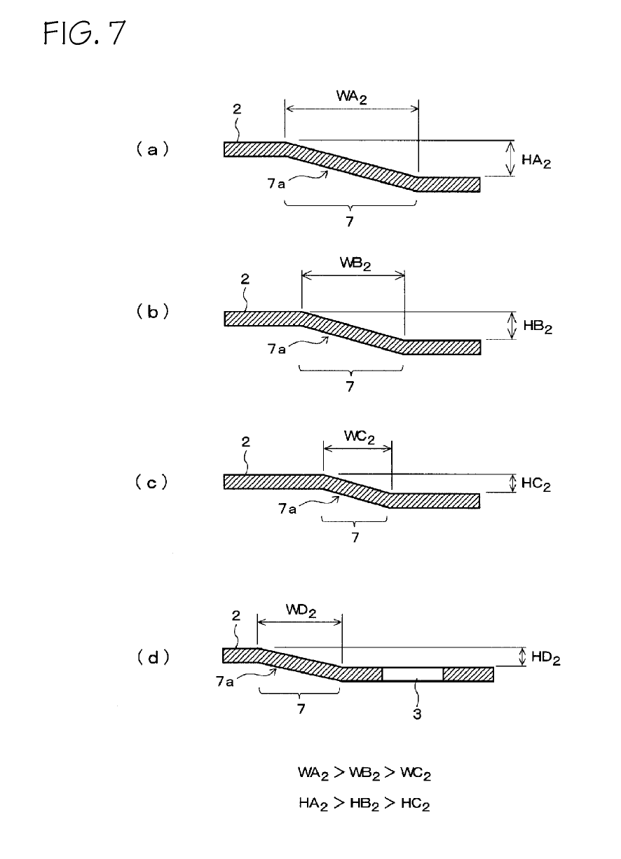

FIG. 6 is a plan view of a third embodiment of a metal gasket according to the present invention, and FIG. 7(a) is a line A₂-A₂ cross-sectional view of FIG. 6, (b) is a line B₂-B₂ cross-sectional view, (c) is a line C₂-C₂ cross-sectional view, and (d) is a line D₂-D₂ cross-sectional view, of FIG. 6. Since those components having the same reference numerals as those in FIG. 1 have the same configurations as them, respectively, the detailed description thereof is omitted here.

The metal gasket 1C comprises a bead 7, which is formed as a half bead over the entire circumference thereof, and which comprises an inclined surface 7a inclined toward the outside of the gasket body 2 (toward a side opposite to the flow passage opening 4) (see FIG. 7), in a manner that the heights H and widths W of the bead in regions positioned between applicable adjacent two bolt holes 3, 3 are the same configuration as those in the first embodiment (HA₂>HB₂>HC₂, WA₂>WB₂>WC₂).

It is noted in FIG. 7 that although the bead 7 is configured to have a height HD₂ and a width WD₂ near each bolt hole 3 such that the width WD₂ is greater than that in each region between adjacent bolt holes 3, 3 (see FIG. 7(c)), it is enough to establish that HC₂≧HD₂ and HC₂×WD₂≧HD₂×WC₂, in consideration of a compressibility just below the applicable bolt.

Further, this bead 7 is formed to have a portion positioned near each bolt hole 3, which portion is passed between the bolt hole 3 and the flow passage opening 4, similarly to the second embodiment.

This metal gasket 1C is also capable of obtaining the same effect as the first embodiment.

### Fourth Embodiment of Metal Gasket

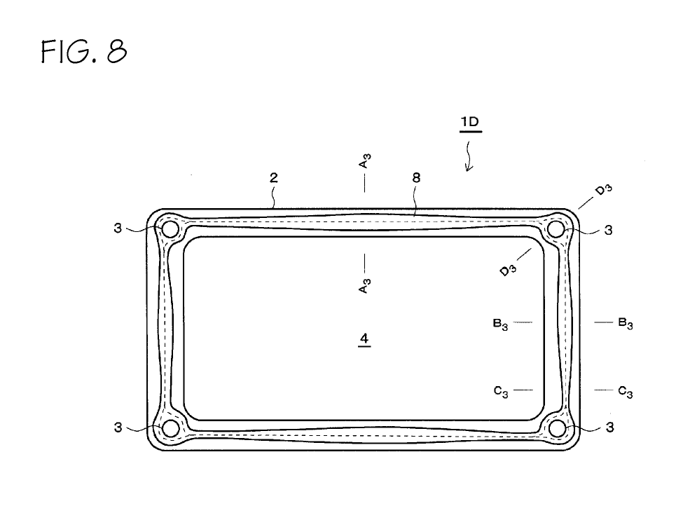

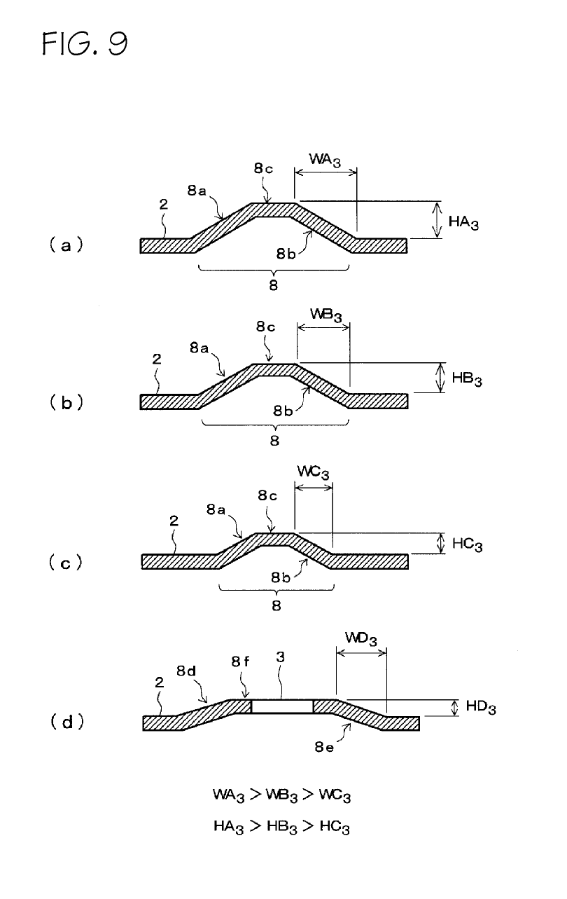

FIG. 8 is a plan view of a fourth embodiment of a metal gasket according to the present invention, and FIG. 9(a) is a line A₃-A₃ cross-sectional view of FIG. 8, (b) is a line B₃-B₃ cross-sectional view, (c) is a line C₃-C₃ cross-sectional view, and (d) is a line D₃-D₃ cross-sectional view, of FIG. 8. Since those components having the same reference numerals as those in FIG. 1 have the same configurations as them, respectively, the detailed description thereof is omitted here.

The metal gasket 1D comprises a bead 8 which is formed as a full bead comprising a trapezoidal bead having inclined surfaces 8a, 8b upwardly inclined from the gasket body 2 and a flat surface 8c formed over top portions of the inclined surfaces 8a, 8b in each region between adjacent two bolt holes 3, 3 (see FIGS. 9(a), (b), and (c)), and formed as half beads in each region near an associated bolt hole 3, which half beads are divided inwardly (flow passage opening 4 side) and outwardly around the associated bolt hole 3 as a boundary and are formed to exhibit inclined surfaces 8d, 8e upwardly inclined from inner and outer edges of the gasket body 2 toward the bolt hole 3, respectively, in a manner to surround an outer circumference of the bolt hole 3 (see FIG. 9(d)). Each bolt hole 3 is opened at a flat surface 8f formed over top portions of the inclined surfaces 8d, 8e.

Also in this metal gasket 1D, the bead 8 is configured to have a height H and a width W which become higher and wider from the vicinity of each bolt hole 3 in a direction separating therefrom, respectively. Preferably, the height H and width W of the bead 8 become progressively higher and wider from the vicinity of each bolt hole 3 in the direction separating therefrom (HA₃>HB₃>HC₃, WA₃>WB₃>WC₃).

It is noted in FIG. 9 that although the bead 8 is configured to have a height HD₃ and a width WD₃ near each bolt hole 3 such that the width WD₃ is greater than that in each region between adjacent bolt holes 3, 3 (see FIG. 9(c)), it is enough to establish that HC₃≧HD₃ and HC₃×WD₃≧HD₃×WC₃, in consideration of a compressibility just below the applicable bolt.

This metal gasket 1D is also capable of obtaining the same effect as the first embodiment.

### First Embodiment of Method for Manufacturing a Die for Metal Gasket

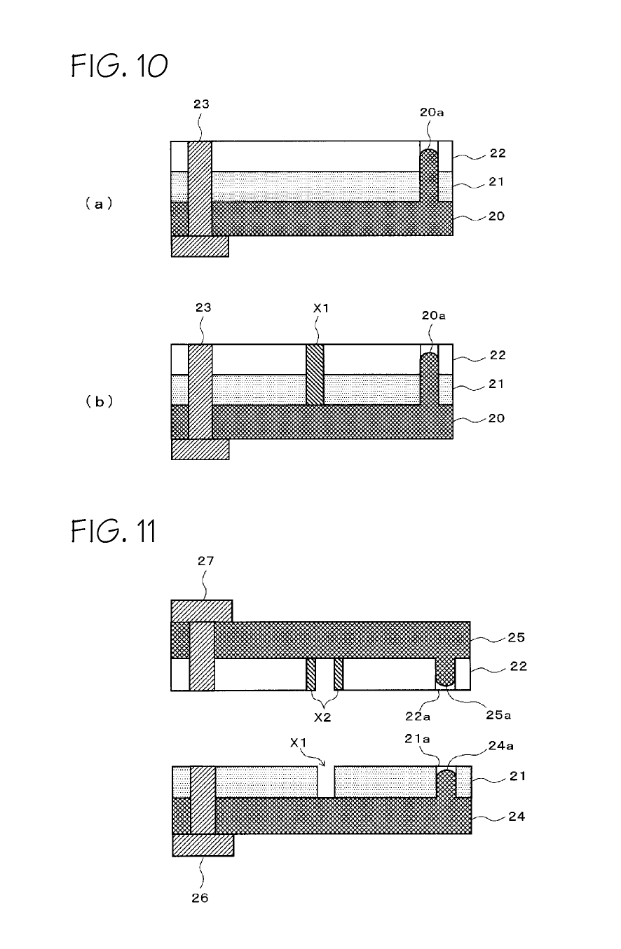

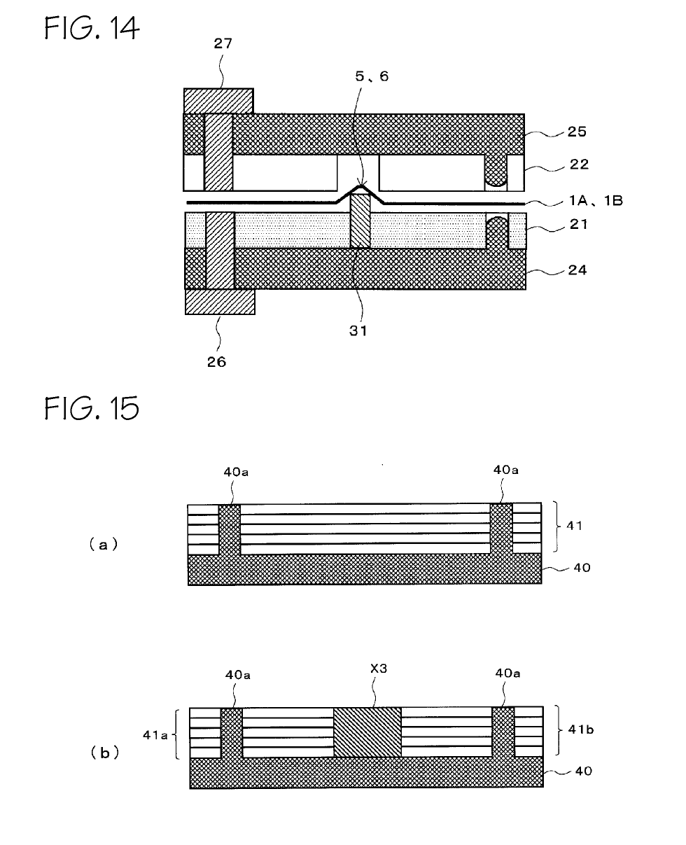

FIG. 10 through FIG. 14 are explanatory views showing a first embodiment of a method for manufacturing a die for metal gasket according to the present invention, and FIG. 10, FIG. 11, FIG. 13, and FIG. 14 each show a cross-section of the die in a direction traversing a bead of a metal gasket to be produced.

The die according to the first embodiment is preferably utilizable in case of producing the metal gaskets 1A, 1B according to the first and second embodiments shown in FIG. 1 through FIG. 5.

In FIG. 10, reference numeral 20 designates a machine plate as a base, and reference numerals 21 and 22 designate die plates to be fabricated into a male die and a female die, respectively, such that the die plates 21, 22 are laid one on top of the other and stacked on the machine plate 20. The die plates 21, 22 are placed in a state positioned by a positioning pin 20a protruded from the machine plate 20 (FIG. 10(a)).

Next, the die plates 21, 22 laid one on top of the other, are subjected to conduction of a first cutting-out operation for forming a first cut-out through both the die plates 21, 22, along a bead shape (full bead) in a metal gasket to be produced and over an entire circumference thereof, by suitable machining means such as a wire cutter, laser, or the like (FIG. 10(b)). The first cut-out is designated by X1 in this figure.

After the first cutting-out operation, the die plates 21, 22 are removed from the machine plate 20, and mounted onto pressing machine plates 24, 25, respectively, which are oppositely arranged one above the other (FIG. 11). The die plates 21, 22 are positioned by positioning pins 24a, 25a protruded from the pressing machine plates 24, 25, and positioning holes 21a, 22a of the die plates themselves, respectively, and are fixed by fixtures 26, 27, respectively.

Further, the first cut-out X1 of the female die plate 22 arranged above in the figure, is subjected to conduction of a second cutting-out operation for forming a second cut-out therealong, which is commensurate with a variation of a bead width of a metal gasket to be produced, over an entire circumference of the first cut-out, by suitable machining means such as a wire cutter, laser, or the like. The second cut-out is designated by X2 in this figure. This second cut-out X2 is thus made to be wider than the first cut-out X1 formed in the male die plate 21. Further, the second cut-out X2 is machinedly formed into the same height as the first cut-out X1 of the female die plate 22.

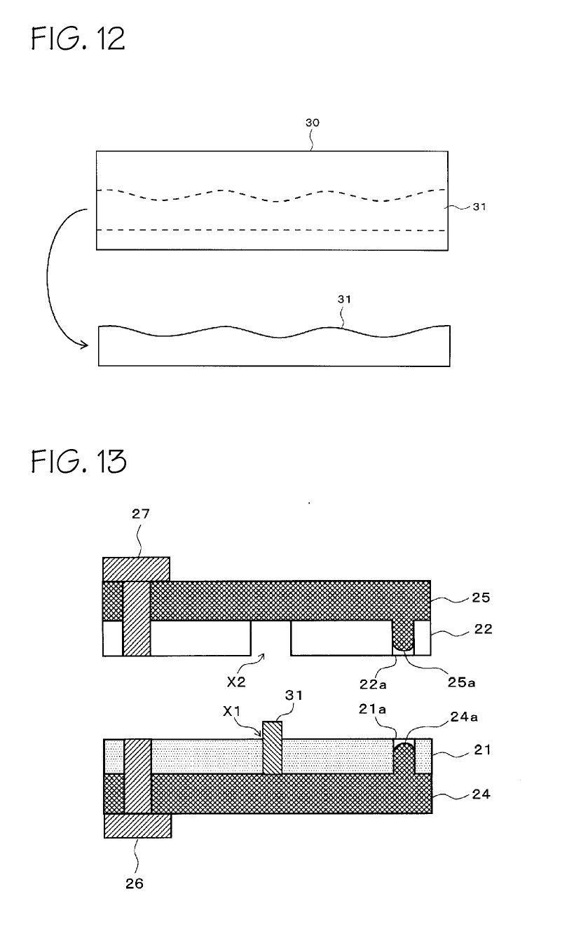

Next, extracted from a metal plate 30 is a protrusive part 31 to be attached to the male die plate 21, commensurately with a height variation of the bead, by a wire cutter, laser machining, or the like (FIG. 12).

Then, the extracted protrusive part 31 is inserted into the first cut-out X1 and fixed therein, which has been cut out into a groove shape in the male die plate 21 (FIG. 13).

This enables to readily produce the metal gasket 1A or 1B having the bead 5 or 6 comprising the full bead with the desired variations of the height and width thereof, by placing a metal material for a gasket between the upper and lower pressing machine plates 24, 25 and by pressing the metal material (FIG. 14).

The height of the bead of the metal gasket is allowed to be readily set by the extracted shape of the protrusive part 31 upon machining it out of the metal plate 30, and the width of the bead is allowed to be readily set by the machined width of the second cut-out X2 for the female metal plate 22, thereby enabling to manufacture the die more readily and more inexpensively than a procedure to directly and fully cut out a die from a metal material.

### Second Embodiment of Method for Manufacturing a Die for Metal Gasket

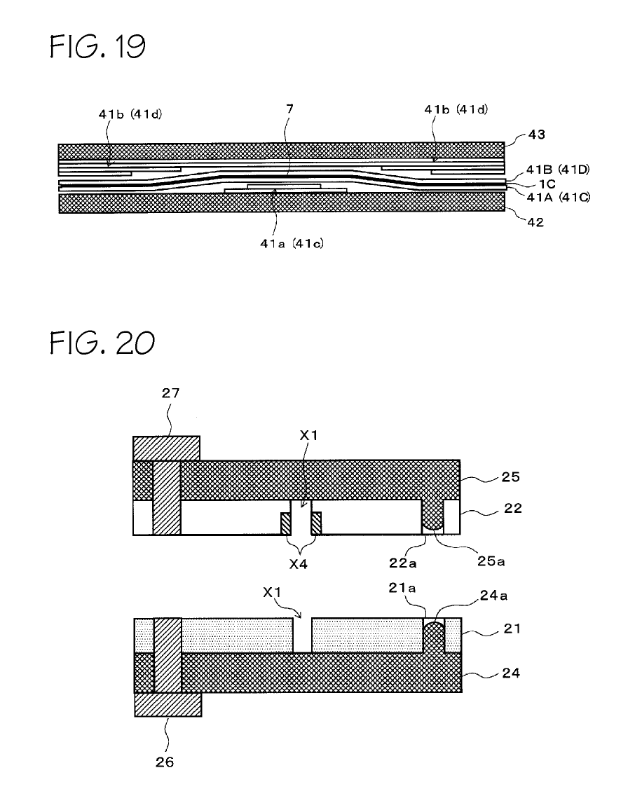

FIG. 15 through FIG. 19 are explanatory views showing a second embodiment of a method for manufacturing a die for metal gasket according to the present invention. FIG. 15 through FIG. 18 each show a cross-section of the die in a direction traversing a bead of a metal gasket to be produced. FIG. 19 shows a cross section of the die in a direction parallel to a bead line.

The die according to the second embodiment is preferably utilizable in case of producing the metal gasket 1C according to the third embodiment shown in FIG. 6 and FIG. 7.

In FIG. 15, reference numeral 40 designates a machine plate as a base, and reference numeral 41 designates a steel plate group comprising stacked thin steel plates to be fabricated into a die, such that the steel plate group 41 is placed, in a state positioned by positioning pins 40a, on the machine plate 40 (FIG. 15(a)).

Next, the steel plate group 41 is subjected to conduction of a cutting-out operation over an entire circumference of a bead (half bead) in a metal gasket, commensurately with a variation of a bead width, by suitable machining means such as a wire cutter, laser, or the like (FIG. 15(b)). The cut-out is designated by X3 in this figure. The steel plate group 41 is divided into inner and outer two blocks (steel plate blocks 41a, 41b) by the cut-out X3.

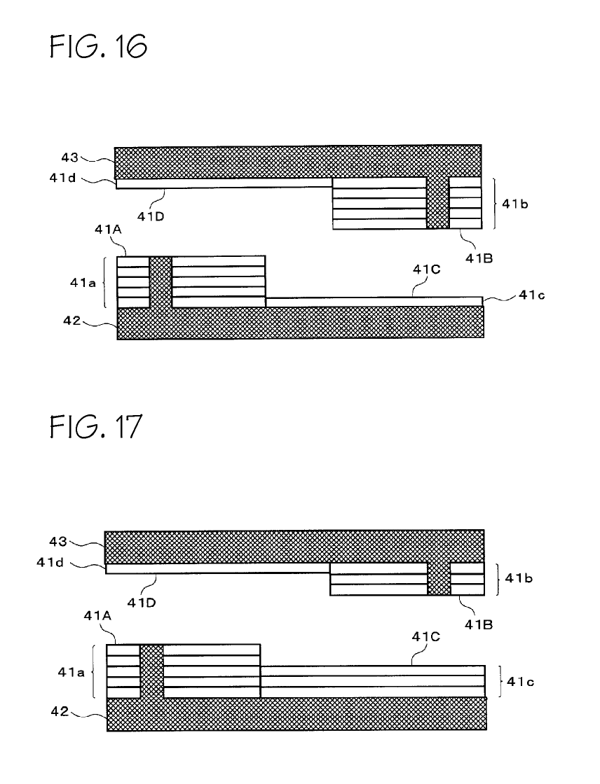

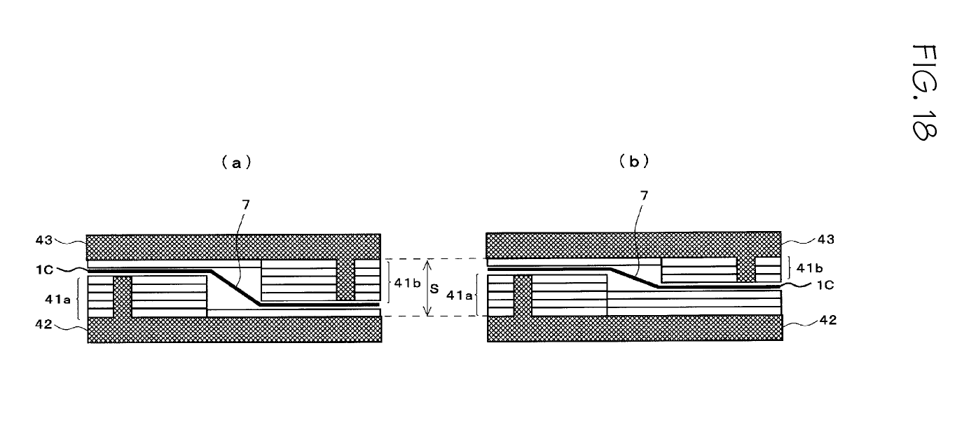

After this cutting-out operation, the steel plate blocks 41a, 41b are removed from the machine plate 40, and mounted onto pressing machine plates 42, 43, respectively, which are oppositely arranged one above the other (FIG. 16 and FIG. 17). The lower steel plate block 41a is mounted onto an inner side of the pressing machine plate 42, and the upper steel plate block 41b is mounted onto an outer side of the pressing machine plate 43, in a manner that a positionally displaced amount between the steel plate blocks is varied commensurately with a variation of a bead width.

At this time, commensurately with the variation of the bead height, varied are: the numbers of constituent steel plates of the steel plate blocks 41a, 41b to be mounted onto the upper and lower pressing machine plates 42, 43, respectively, at respective locations in the circumferential direction; and steel plate blocks 41c, 41d to be arranged on the pressing machine plates 42, 43, in a manner to oppose to the mating steel plate blocks 41b, 41a; by partially adding or removing a steel plate(s). It is possible to readily vary heights of die surfaces commensurately with slight variations of the bead height, by simply adjusting the numbers of constituent steel plates of the steel plate blocks 41a to 41d, respectively, because thin steel plates are used simply.

It is noted that topmost steel plates 41A to 41D to be mounted on the pressing machine plates 42, 43 are each provided by a single steel plate which is continuous over an entire circumference thereof. Those steel plates to be stacked under the steel plates 41A to 41D, are to be mounted onto the upper and lower pressing machine plates 42, 43, in a manner to be partly separated from the steel plate blocks 41a to 41d, respectively. This enables to form die surfaces to be contacted with a metal material for gasket, which die surfaces are continuous and smoothly varied over the entire circumferences thereof, respectively.

FIGS. 18(a) and (b) show states upon formation of bead portions having different bead heights, respectively. It is understood that the height of the bead 7 to be formed can be variously changed even when the bead height is varied in this manner, by appropriately changing the numbers of constituent steel plates of the steel plate blocks 41a to 41d, respectively. At this time, the pressing machine plates 42, 43 are kept away from each other by a spacing S upon pressing, which spacing is the same at any location, thereby never bringing about a fluctuation of a pressure upon pressing.

Further, by placing a metal material for gasket between the upper and lower pressing machine plates 42, 43, and by pressing the metal material, it becomes possible to readily produce the metal gasket 1C having the bead 7 comprising the half bead with the desired variations of the height and width thereof.

FIG. 19 shows the bead 7 at a portion thereof positioned between adjacent two bolt holes, in a section parallel to the bead line. In this way, even when the height of the bead 7 is to be progressively varied from each bolt hole in the direction separating therefrom, it is possible to readily deal with it, by appropriately adjusting the numbers of constituent steel plates of the steel plate blocks 41a to 41d, respectively, for forming the die surfaces, commensurately with those locations where the height of the bead is desired to be varied. This enables to manufacture the die more readily and more inexpensively than a procedure to directly and fully cut out a die from a metal material.

It is noted that, since the topmost steel plates 41A to 41D (surfaces to be contacted with a metal material for gasket) to be mounted on the pressing machine plates 42, 43 are continuous over the entire circumferences of the steel plates, respectively, those steel plates are to be used as topmost ones, which are never deformed even upon formation of a bead and which have thicknesses smoothly varied commensurately with changes of the numbers of steel plates of the steel plate blocks 41a to 41d to be stacked under the topmost steel plates, respectively.

Although the thicknesses of the topmost steel plates 41A to 41D are to vary depending on the thicknesses of the steel plate blocks 41a to 41d to be stacked under the steel plates 41A to 41D so as to vary the bead height, the thicknesses of the steel plates 41A to 41D are preferably 0.5 to 2 mm.

### Third Embodiment of Method for Manufacturing a Die for Metal Gasket

FIG. 20 through FIG. 23 are explanatory views showing a third embodiment of a method for manufacturing a die for metal gasket according to the present invention, and FIG. 20, FIG. 22, and FIG. 23 each show a cross-section of the die in a direction traversing a bead of a metal gasket to be produced.

The die according to the third embodiment is preferably utilizable in case of producing the metal gasket 1D according to the fourth embodiment shown in FIG. 8 and FIG. 9.

Also in this manufacturing method according to the third embodiment, male and female die plates 21, 22 to be used are formed therethrough with a first cut-out X1 over an entire circumference along a bead shape of a metal gasket to be produced, by appropriate machining means such as a wire cutter, laser, or the like. This process can be conducted in the same manner as the method shown in FIG. 10 in the manufacturing method according to the first embodiment, and the explanation of the process is thus omitted here. Further, those components having the same reference numerals as those in FIG. 10, FIG. 11, and FIG. 13 have the same configurations as them, respectively.

After forming the first cut-out X1, the die plates 21, 22 are removed from the machine plate 20, and mounted onto pressing machine plates 24, 25, respectively, which are oppositely arranged one above the other (FIG. 20). The die plates 21, 22 are positioned by positioning pins 24a, 25a protruded from the pressing machine plates 24, 25, and positioning holes 21a, 22a of the die plates themselves, respectively, and are fixed by fixtures 26, 27, respectively.

Further, the female die plate 22 arranged above in the figure, is subjected to conduction of a cutting-out operation for forming a second cut-out, which is commensurate with a variation of a bead width of a metal gasket to be produced, over an entire circumference thereof, by suitable machining means such as a wire cutter, laser, or the like. The second cut-out is designated by X4 in this figure. This second cut-out X4 is thus made to be wider than the first cut-out X1 formed in the male die plate 21, and is formed to be shallower than the elaborated depth of the first cut-out X1 formed in the female die plate 22 itself. Thus, the female die plate 22 is brought into a configuration having the first cut-out X1 in a narrow groove shape at the bottom of the second cut-out X4.

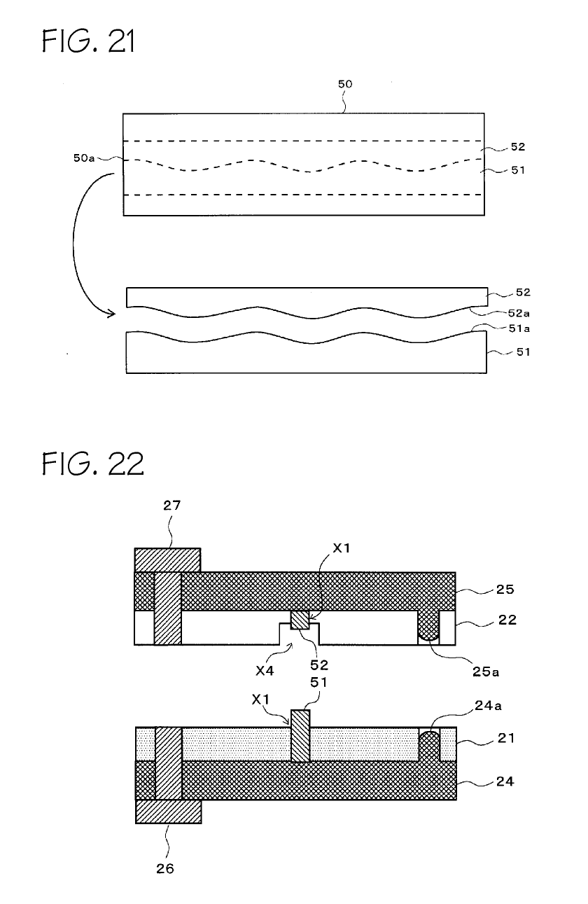

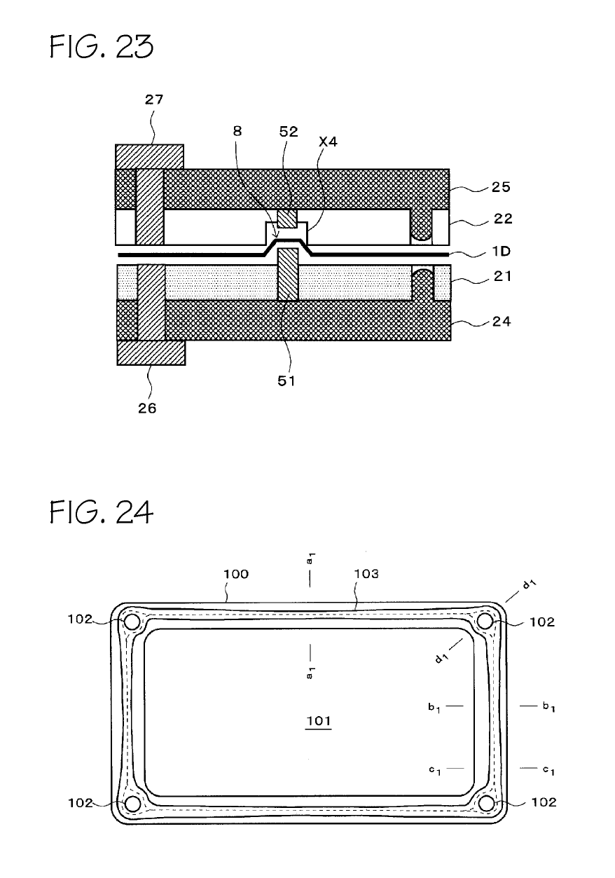

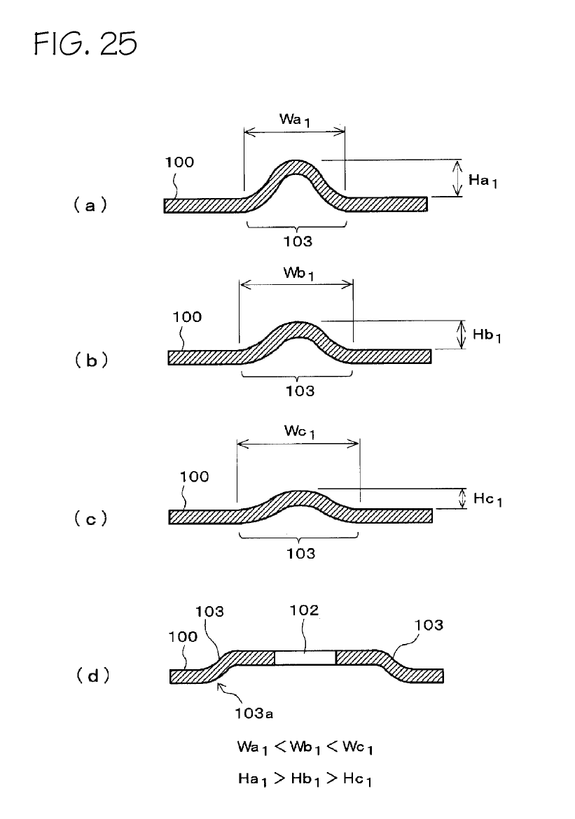

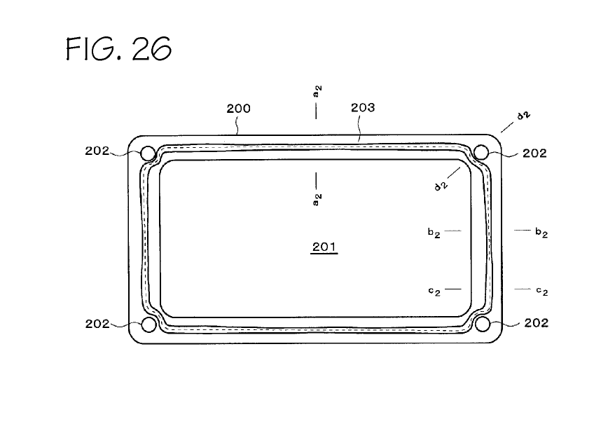

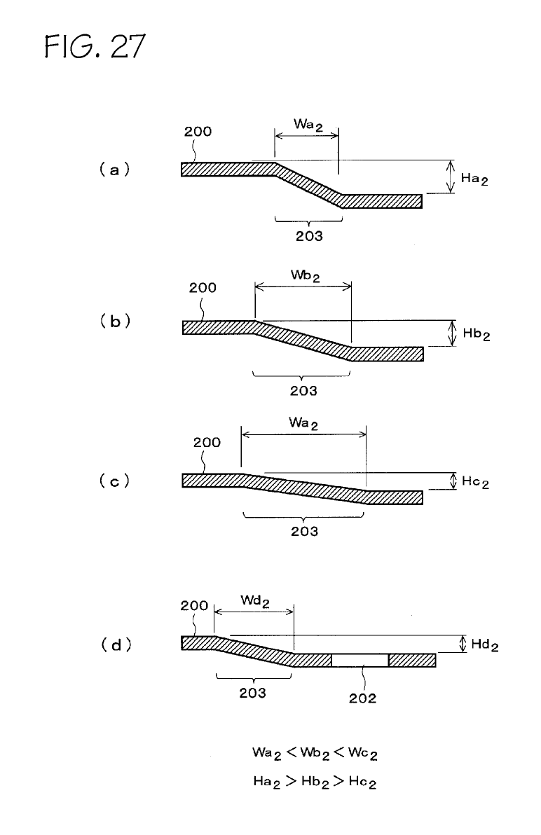

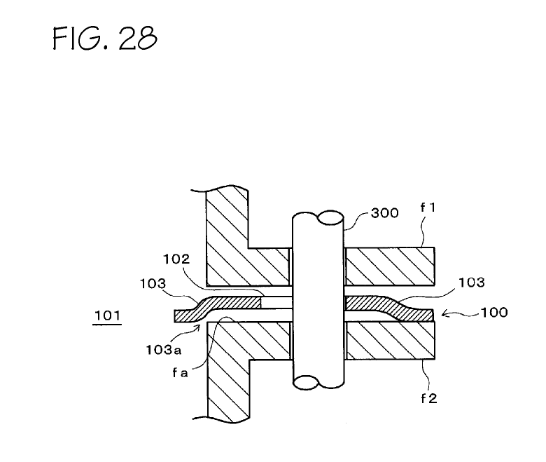

Next, extracted from a metal plate 50 are protrusive parts 51, 52 to be attached to the male die plate 21 and female die plate 22, respectively, by forming a shaped plane 50a in the metal plate 50 which shaped plane has a height variation commensurate with a height variation of the bead, by a wire cutter, laser machining, or the like (FIG. 21). The shaped plane 50a is common to the protrusive parts 51, 52, and the single metal plate 50 is thus oppositely divided into two metal plates along and from the shaped plane 50a interposed therebetween. One of the dividedly obtained two metal plates is established into the protrusive part 51 to be mounted onto the male die plate 21, and the other is established into the protrusive part 52 to be mounted onto the female die plate 22. Opposite surfaces 51a, 52a of the protrusive parts 51, 52, respectively, have the same shape because these surfaces are formed by the common shaped plane 50a, such that the surfaces 51a, 52a are mated with each other when they are abutted on each other.

Then, one 51 of the extracted protrusive parts is inserted into the first cut-out X1 and fixed therein, which has been cut out into a groove shape in the male die plate 21, and the other protrusive part 52 is inserted into the part of the first cut-out X1 located in the second cut-out X4 and is fixed in the first cut-out X1, which second cut-out X4 has been cut out into a groove shape in the female die plate 22 (FIG. 22).

This enables to readily produce the metal gasket 1D having the bead 8 with the desired variations of the height and width thereof, by placing a metal material for a gasket between the upper and lower pressing machine plates 24, 25 and by pressing the metal material (FIG. 23). The full bead portion at this time is formed into a trapezoidal bead having a top surface acting as the flat surface 8c, because the metal material is pressurized from the above and below by the protrusive parts 51 and 52, thereby enabling to readily form half beads having top surfaces acting as flat surfaces, respectively, even near each bolt hole.

Also by this method, the height of the bead of the metal gasket is allowed to be readily set by the extracted shapes of the protrusive parts 51, 52 upon machining them out of the metal plate 50, and the width of the bead is allowed to be readily set by the machined width of the second cut-out X4 for the female metal plate 22, thereby enabling to manufacture the die more readily and more inexpensively than a procedure to directly and fully cut out a die from a metal material. Moreover, the protrusive parts 51, 52 are extracted from the single metal plate 50 by forming the commonly shaped plane 50a, thereby enabling to readily ensure the matching precision between the upper and lower die plates 21, 22.

1. A metal gasket to be provided for sealing joint surfaces between two members, the metal gasket comprising:
a flow passage opening which corresponds to a flow passage provided between and through the two members;
multiple bolt holes, through which bolts for tightening the two members to each other are penetrated; and
a bead;
wherein the bead is configured to have a height and a width which become higher and wider from the vicinity of each bolt hole in a direction separating therefrom.

2. The metal gasket according to claim 1, wherein the height and width of the bead become progressively higher and wider from the vicinity of each bolt hole in the direction separating therefrom.

3. The metal gasket according to claim 1, wherein the bead is formed as a full bead in each region between adjacent two bolt holes, and formed as half beads in each region near an associated bolt hole in a manner to surround the bolt hole.

4. The metal gasket according to claim 3, wherein the bead is formed as a trapezoidal bead in each region between adjacent two bolt holes, such that the trapezoidal bead has a top surface formed as a flat surface.

5. The metal gasket according to claim 1, wherein the bead is entirely formed as a full bead, and the bead is formed to be positioned near each bolt hole in a manner to pass between the bolt hole and the flow passage opening.

6. The metal gasket according to claim 1, wherein the bead is entirely formed as a half bead, and the bead is formed to be positioned near each bolt hole in a manner to pass between the bolt hole and the flow passage opening.

7. A method for manufacturing a die for metal gasket, the die being adapted to produce a metal gasket comprising a gasket body and a bead, the bead having a height and a width varied over an entire circumference of the gasket body, the method comprising:
a first cutting out step configured to lay a male die plate and a female die plate one on top of the other, and to form a first cut-out through both the die plates, along a bead shape to be produced;
a second cutting out step configured to mount the male die plate and the female die plate after the first cutting-out operation, onto oppositely arranged pressing machine plates, and to subsequently conduct a second cutting-out operation, which is set to be wider commensurately with a width variation of the bead to be produced, for the first cut-out in the female die plate;
a protrusive part forming step configured to form, from a metal plate, a die protrusive part for determining a bead height, in a manner that the protrusive part has a height variation commensurate with a height variation of the bead to be produced; and
a protrusive part fixing step configured to insert and fix the protrusive part formed by the protrusive part forming step, into the first cut-out in the male die plate which first cut-out has been cut out by the first cutting out step.

8. A method for manufacturing a die for metal gasket, the die being adapted to produce a metal gasket comprising a gasket body and a bead, the bead having a height and a width varied over an entire circumference of the gasket body, the method comprising:
a steel plate block forming step configured to stack multiple steel plates, and to conduct a cutting-out operation throughout all the steel plates commensurately with a width variation of the bead to be produced, thereby forming two steel plate blocks; and
a mounting and adjusting step configured to mount the formed steel plate blocks onto oppositely arranged pressing machine plates, by adjusting the numbers of constituent steel plates of the steel plate blocks at respective locations in the circumferential direction commensurately with the variation of the bead height.

9. The method for manufacturing a die for metal gasket according to claim 8, wherein those topmost ones of the steel plates mounted on the pressing machine plates, each comprise a single steel plate which is continuous over an entire circumference thereof.

10. A method for manufacturing a die for metal gasket, the die being adapted to produce a metal gasket comprising a gasket body and a bead, the bead having a height and a width varied over an entire circumference of the gasket body, the method comprising:
a first cutting out step configured to lay a male die plate and a female die plate one on top of the other, and to form a first cut-out through both the die plates, along a bead shape to be produced;
a second cutting out step configured to mount the male die plate and the female die plate after the first cutting-out operation, onto oppositely arranged pressing machine plates, and to subsequently conduct a second cutting-out operation for forming a second cut-out, which is set to be wider commensurately with a width variation of the bead to be produced and which is shallower than the first cut-out;
a protrusive part forming step configured to form, from a metal plate, a pair of die protrusive parts for determining a bead height, in a manner that the pair of protrusive parts cooperatively have a height variation commensurate with a height variation of the bead to be produced; and
a protrusive part fixing step configured to insert and fix one of the pair of protrusive parts formed by the protrusive part forming step into the first cut-out in the male die plate, to fix the protrusive part in the first cut-out, and to insert and fix the other of the pair of protrusive parts into the first cut-out in the female die plate.

11. The method for manufacturing a die for metal gasket according to claim 10, wherein the metal plate comprises a single metal plate, and the protrusive part forming step is configured: to form a shaped plane in the single metal plate which shaped plane has a height variation commensurate with the height variation of the bead to be produced, in a manner to divide the single metal plate into two metal plates along and from the shaped plane interposed therebetween; and to constitute the protrusive parts of the male die plate and the female die plate by one and the other of the dividedly obtained metal plates, respectively.

12. The metal gasket according to claim 2, wherein the bead is formed as a full bead in each region between adjacent two bolt holes, and formed as half beads in each region near an associated bolt hole in a manner to surround the bolt hole.

13. The metal gasket according to claim 12, wherein the bead is formed as a trapezoidal bead in each region between adjacent two bolt holes, such that the trapezoidal bead has a top surface formed as a flat surface.

14. The metal gasket according to claim 2, wherein the bead is entirely formed as a full bead, and the bead is formed to be positioned near each bolt hole in a manner to pass between the bolt hole and the flow passage opening.

15. The metal gasket according to claim 2, wherein the bead is entirely formed as a half bead, and the bead is formed to be positioned near each bolt hole in a manner to pass between the bolt hole and the flow passage opening.
